(19) United States
(12) Patent Application Publication
(10) Pub. No.: US 2003/0163329 A1
(43) Pub. Date: Aug. 28, 2003

(54) METHOD FOR DEFINING AN EXECUTABLE BUSINESS MODEL

(76) Inventor: DAVID BOLENE, AUSTIN, TX (US)

Correspondence Address: JENKENS & GILCHRIST, PC, 1445 ROSS AVENUE, SUITE 3200, DALLAS, TX, 75202, US

(21) Appl. No.: 09/400,231

(22) Filed: Sep. 21, 1999

(51) Int. Cl. G06F 17/60; G06F 9/44

(52) U.S. Cl. 705/1; 717/120

(57) ABSTRACT

A Demand Management Framework (DMF) business application software is disclosed that includes a small, select set of business abstractions that can be applied over and over again to create a variety of executable business models. The main DMF core abstractions are: (1) Aspect, which identifies a particular business entity; and (2) Fractal Aspect, which identifies particular aspects of the business entity. Within the Fractal Aspect abstraction, various additional abstractions can be defined, such as the responsible party of the business entity (Party), the spatial location of the business entity (Location), the physical item(s) within the spatial location of the business entity (Item) and the functional activity of the business entity (Activity). Business analysts create instances of Party, Location, Item, and Activity as components in the runtime, and connect them together along with business rules and other component definitions to form an executable business model.

### BACKGROUND OF THE PRESENT INVENTION

1. Field of the Invention

The present invention is directed to methods for defining executable software business models, and specifically to methods for performing business activities using an executable software business model.

2. Background and Objects of the Present Invention

Since the 1950's, business application software has been developed through a process of analyzing software automation problems and producing solution-specific software code for each automation problem. When these different solution programs (or modules) are pieced together, they form a complete system. The resulting systems are typically difficult to modify or update because the structure of these systems is a complex web of code-interconnected point solutions with embedded control flow and embedded business policies.

However, the business world is an ever-changing and increasingly dynamic environment. Software developers, strapped by the systems they must maintain, have not been able to keep up with business change, which results in software development backlogs. Thus, instead of leveraging software assets, businesses spend much of their time trying to work around the software. In addition, typically the more software that is in place, the harder it is to add additional software.

Object-orientation and software component technologies are positioned to help solve these problems. Object-orientation is a set of design concepts and software languages that when properly applied enable the development of generalized software known as frameworks. Frameworks are abstract solutions that are extended with additional code to address the specifics of a particular automation problem. The goal of object-orientation is that eventually after enough application automation problems are experienced, generalized solutions will be developed that eliminate the requirement to build software from scratch. Software component technology is a set of software organizing principles that help to further modularize software and make it reusable in a variety of applications. Software component technology breaks down the software into reusable pieces, similar to lego-blocks. These pieces are then “snapped” together to form application systems.

Both of these technologies (object-orientation and software component) have the ability to make software construction and evolution easier and faster. However, to achieve this goal, these technologies must be properly applied. Building modern object-oriented component software systems requires experience and time, and has typically been a risky and expensive endeavor for businesses. This is especially true in the Internet age where the computing environment is growing ever more complex with a multitude of existing and emerging technologies that must be continually studied and mastered. The Internet has also accelerated the need for shared systems level software, such as collaborative workflow and shared business objects. However, implementing such shared software systems has proved difficult to achieve.

In addition, reuse of business application functionality across application problem domains is virtually non-existent. Most object-oriented developers approach the process in a very problem focused way. Therefore, the resulting business-oriented frameworks end up being generalized for only the specific problem domains that inspired the development. As a consequence, the resulting system is a combination of point solutions that must be interfaced to each other in a multitude of different ways.

The requirements of adaptive software, shared software and reusable software have dramatically increased the complexity of business application software development. In addition to these requirements, the fundamental problem of the language gap between the business and information systems groups has also increased the complexity of producing real business automation software solutions. For example, business analysts speak and think in terms of organizations, business rules, business processes, products, services and quality of business performance, whereas information systems professionals must immerse themselves in an arcane world of acronyms and computer level mechanisms just to stay current on technology. Entire methodologies currently exist to bridge this gap. These methodologies are tedious and time consuming, and do not truly address the problem.

It is, therefore, an object of the present invention to provide a reusable and adaptive business application software that can be shared across the industry and within the Internet.

It is a further object of the present invention to enable business analysts to define and assemble executable business models using business level language, without requiring additional code.

### SUMMARY OF THE PRESENT INVENTION

The present invention is directed to a Demand Management Framework (DMF) business application software that includes a reusable, adaptable and extensible software framework, which enables the rapid construction of business applications through component assembly technology. The resulting applications inherently inter-operate, adapt and scale across businesses, business functions and the Internet. Core functions and components are shareable across businesses and business functions, yet the specific automation solutions can be customized to each business. In addition, application assembly takes place at a business language level by business analysts, without programmer intervention. Essentially, the DMF includes a small, select set of business abstractions that can be applied over and over again to create a variety of executable business models. The main DMF core abstractions are: (1) Aspect, which identifies a business object of a particular business entity; and (2) Fractal Aspect, which identifies perceptual dimensions of the business entity. Within the Fractal Aspect abstraction, various additional abstractions can be defined, such as the responsible party of the business entity (Party), the spatial location of the business entity (Location), the physical item(s) within the spatial location of the business entity (Item) and the functional activity of the business entity (Activity). The DMF provides the ability to context shift between various Fractal Aspects. In addition, the various Fractal Aspects can be associated in a hierarchical relationship that can be modified at any time, with each Fractal Aspect having the ability to have multiple hierarchical parents. Business analysts create instances of Party, Location, Item and Activity as components in the runtime, and connect them together along with business rules and other component definitions to form an executable business model. Under business model control, users act as agents for consumer Parties and create Demands on other supplier Parties for Activities and/or Items. The DMF can track the progress of these demands, using Trackers, and display real-time, up-to-date summarized views of the progress. The DMF also includes a WorkList that serves as a queue for Trackers and Demands awaiting system or user attention. In addition, if value exchanges between Parties during the performance of a Demand, the DMF can record and display this value.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating the core abstractions for the Demand Management Framework (DMF) business application software;

FIG. 2 is a block diagram illustrating the Fractal Aspects of the DMF;

FIG. 3 is a flowchart showing the steps for defining an executable business model in accordance with preferred embodiments of the present invention;

FIG. 4 is a block diagram illustrating the concept of Fractal Aspect hierarchy;

FIG. 5A is a block diagram illustrating a sample Accept Order Process hierarchy;

FIG. 5B is a flowchart illustrating a sample Accept Order Process;

FIG. 5C is a block diagram illustrating an Activity Legend for the sample Accept Order Process shown in FIG. 5B of the drawings;

FIG. 6 is a block diagram illustrating the concept of Demand symmetry;

FIG. 7 is a block diagram illustrating the Tracker Core abstraction;

FIG. 8 is a block diagram illustrating a Tracker stack;

FIG. 9 is a block diagram illustrating a specialization of the Party Fractal Aspect;

FIG. 10 is a block diagram illustrating Trackers queued as tasks in a WorkList;

FIG. 11 is a flow chart illustrating the steps for performing a sample business activity in accordance with preferred embodiments of the present invention;

FIG. 12 is a screen shot of a Dashboard;

FIG. 13 is a screen shot of a User Control Panel;

FIG. 14 is a screen shot of a Monitor view;

FIG. 15 is a block diagram illustrating the process of posting to Monitor views;

FIG. 16 is a block diagram illustrating the Value Transfer Core abstraction;

FIG. 17 is a block diagram illustrating the execution of the DMF system on a server in a data network; and

FIG. 18 is a flowchart illustrating the steps for a sample execution of a business activity using the DMF system shown in FIG. 17 of the drawings.

### DETAILED DESCRIPTION OF THE PRESENTLY PREFERRED EXEMPLARY EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

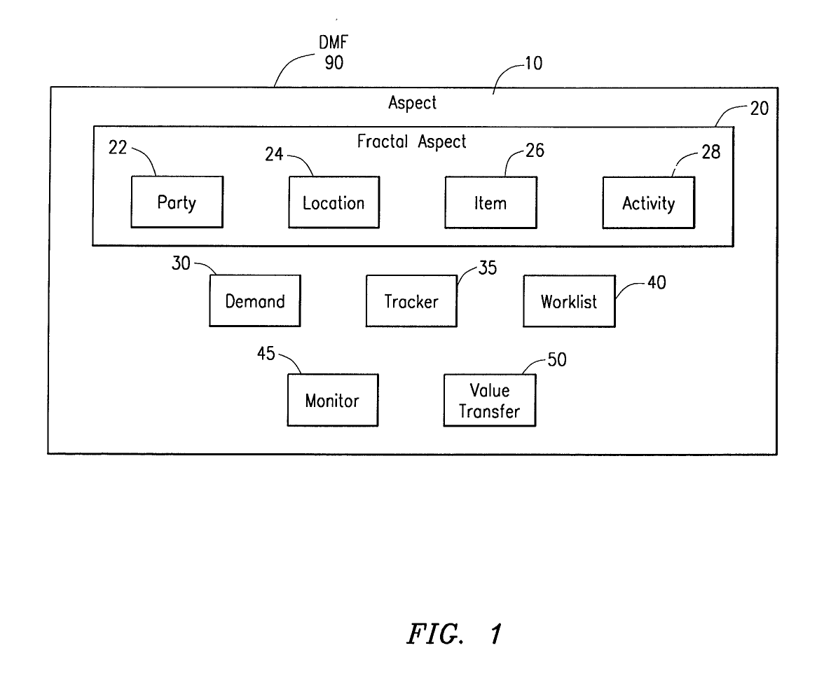

With reference now to FIG. 1 of the drawings, an exemplary block diagram is shown illustrating the basic components of the Demand Management Framework (DMF) business application software 90. Essentially, the DMF 90 includes a small, select set of business abstractions that can be applied over and over again to create a variety of executable business models. The main DMF 90 core abstractions are: (1) Aspect 10, which identifies a business object of a particular business entity; and (2) Fractal Aspect 20, which identifies perceptual dimensions of the business entity.

Within the Fractal Aspect abstraction 20, various additional abstractions can be defined, such as the responsible party of the business entity (Party 22), the spatial location of the business entity (Location 24), the physical item(s) within the spatial location of the business entity (Item 26) and the functional activity of the business entity (Activity 28). Business analysts create instances of Party 22, Location 24, Item 26 and Activity 28 as components in the runtime and connect them together along with business rules and other component definitions to form an executable business model.

In addition, within the Aspect abstraction 10 are the additional abstractions of Demand 30, Tracker 35, WorkList 40, Monitor 45 and Value Transfer 50. Under business model control, users act as agents for consumer Parties 22 and create Demands 30 on other supplier Parties 22 for Activities 28 and (Item 26) work products. When Demands 30 get released for fulfillment, Trackers 35 are created to track Demand 30 satisfaction of the performance of the Activities 28. The WorkList 40 serves as a queue for Trackers 35 and Demands 30 awaiting system or user attention. Value Transfers 50 are created when Parties 22 acknowledge value exchange among themselves. Finally, Monitor 45 is used to provide real-time up-to-date summary views of business Activities 28.

In addition to business abstractions, the DMF 90 supplies two key enabling technologies that facilitate business model expression and change. One technology is called Dynamic Attribution. Dynamic Attribution is a mechanism that supports business object definition without coding. This technology involves users describing a model of an object's attributes. An object created with such a model has attribute values added at runtime. This technology is useful for product definition, user survey composition, and other meta-modeling exercises that require object definition in the runtime without software coding, compiling, and installation.

Another supporting technology provided by the DMF is Revision Control. Revision Control is a mechanism that enables versioning and reversioning of business model components. This technology is useful for supporting controlled change and managed production release of business rules, business processes, product specifications, and customer order revisions. In addition, Revision Control works across all of the DMF abstractions.

Thus, with Dynamic Attribution and Revision Control, the DMF 90 abstractions provide for massive reuse across business application domains. In addition, this allows the DMF 90 to context shift and context track among different Fractal Aspects 20 of the business model. Furthermore, the DMF's 90 capabilities can be reflexively applied back upon itself to facilitate changing states in an effort to achieve better results next time. Therefore, the cost of addressing new business automation problems goes down over time due to the DMF's 90 ability to allow business analysts to reuse features and functions that were previously developed and to only have to incrementally build new components.

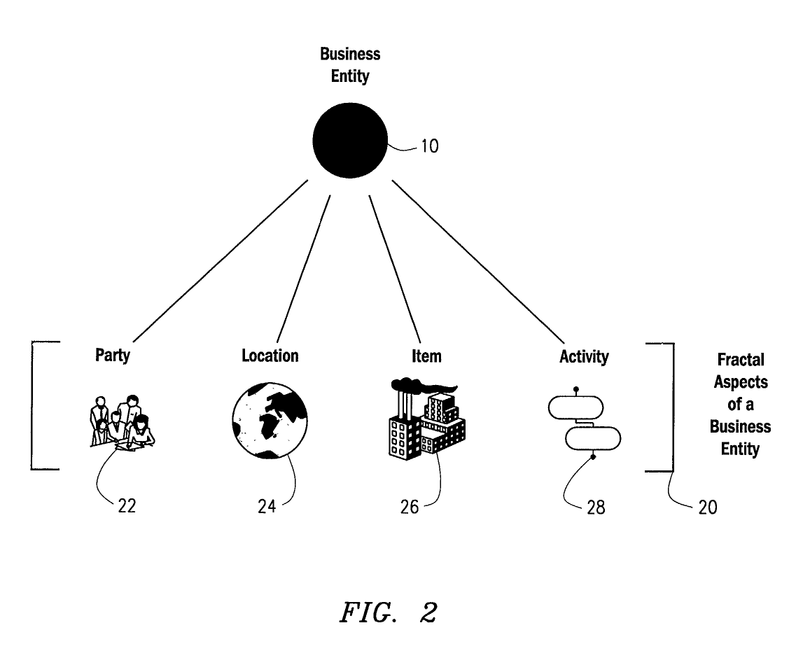

With reference now to FIG. 2 of the drawings, the executable business models created by business analysts are a fractal representation of business structure across a set of interrelated dimensions of responsibility (organizational) structure, spatial topology, physical structure (plant and equipment), and functional structure. An executable DMF business model can be created by first assembling components (Fractal Aspects 20) that represent the Party 22, Location 24, Item 26 and Activity 28 of the Business Entity (Aspect 10) of the business model.

For example, a Business Entity (Aspect 10) can be a Corporation (Party 22) that can be looked upon responsibly as an organization capable of satisfying demand. The Business Entity 10 can also be looked upon as something physical (Item 24) in terms of its plant and equipment. It is also something spatial (Location 26) in terms of the collection of the locations it occupies, e.g., corporation headquarters. It is also something functional (Activity 28), which at an abstract level is the sum of the business processes it is capable of executing. On a different level, the Business Entity 10 is all of these things at once. Each of these Fractal Aspects 20 is traditionally treated as a distinct and standalone software representation. However, in the DMF, these Fractal Aspects 20 are inter-related to form a more complete representation of the real thing.

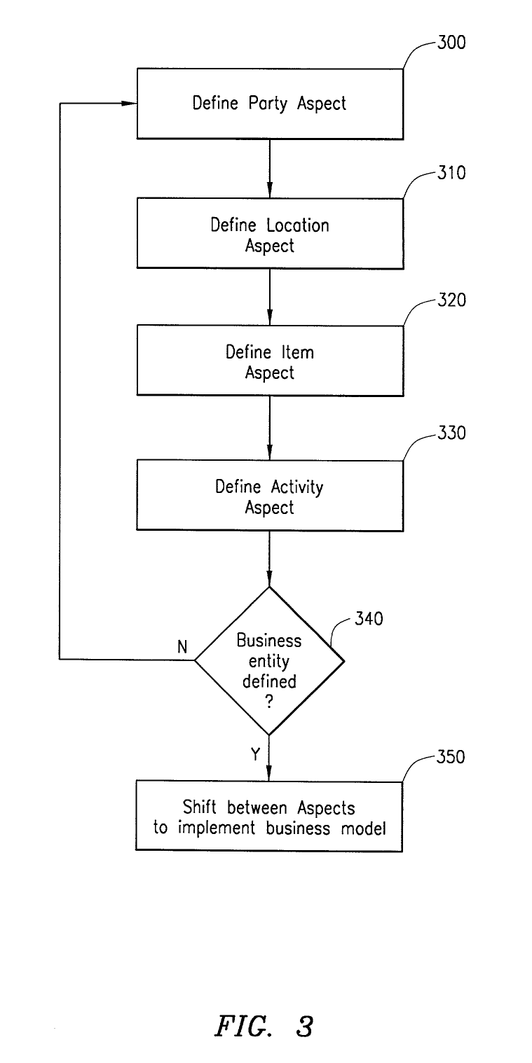

As an example, with reference now to the steps listed in FIG. 3 of the drawings, which will be described in connection with FIG. 2 of the drawings, a sample executable business model can be created by defining the Fractal Aspects 20 of a Business Entity 10, e.g., XYZ Corporation. Initially, the business analyst can begin by defining the Party 22 (step 300), Location 24 (step 310), Item 26 (step 320) and Activity 28 (step 330) for the XYZ Corporation 10 as a whole. For example, the Fractal Aspects 20 for the XYZ Corporation 10 may be:

XYZ Corporation:

| | |
|---|---|
| Party (Responsible) Aspect: | XYZ Corporation |
| Location (Spatial) Aspect: | Set of all XYZ |
| | Corporation Locations |
| Item (Physical) Aspect: | Set of all XYZ |
| | Plant and Equipment |
| Activity (Functional) Aspect: | Run XYZ Corporation |

Inside the XYZ Corporation 10 there may be other sub-entities, such as the XYZ Customer Service Department and the XYZ Warehousing Department. The Fractal Aspects 20 for the XYZ Customer Service Department Aspect may be defined as:

XYZ Customer Service Department:

| | |
|---|---|
| Party: | XYZ Customer Service Department |
| Location: | 124 S. Main St., Stillwater OK, |
| | 74074, USA, Suite 102 |
| Item: | XYZ Customer Service. Dept. Plant |
| | and Equipment |
| Activity: | Run XYZ Customer Service Dept. |

Likewise, the Fractal Aspects 20 for the XYZ Warehousing Department Aspect may be defined as:

XYZ Warehousing Department:

| | |
|---|---|
| Party: | XYZ Warehousing Department |
| Location: | 2305 Perkins Rd., Stillwater OK, |
| | 74074, USA |
| Item: | XYZ Warehousing Dept. Plant and |
| | Equipment |

Activity: Run XYZ Warehousing Dept.

This same pattern can be repeated numerous times to describe the various Fractal Aspects 20 of the Business Entity (XYZ Corporation) 10 (step 340).

A particular specialization of the DMF Party abstraction 22 is called the Party Capability. In addition to the usual Party Fractal Aspects 22, such as Departments, there are other Party Fractal Aspects 22 of the Business Entity 10, such as business processes (procedures), resources, business rules, employee positions, etc. These types of Parties 22 are referred to as Party Capabilities.

A Party Capability has the ability to represent a work-center as a miniature business that is staffed with employees. For example, the XYZ Corporation Customer Service Department may have the capability to accept orders for products. Thus, the Fractal Aspects 20 for this capability may be defined as:

XYZ Party Capability to Accept an Order

| | |
|---|---|
| Party: | Party Capability to Accept an Order |
| Location: | www.xyz.com/acceptOrder.html |
| Item: | none - automated via the computer |
| Activity: | Accept Order Process |

In addition, the XYZ Warehousing Department may have the capability to fulfill orders. Therefore, the Fractal Aspects 20 for this capability may be:

XYZ Party Capability to Fulfill an Order

| | |
|---|---|
| Party: | Party Capability to Fulfill an Order |
| Location: | XYZ Warehouse Pack and Ship Area |
| Item: | Packaging and Shipment Preparation |
| | Equipment |
| Activity: | Package and Ship Process |

Thus, a Party Capability represents a fundamental element of business design. It binds a process, a space where work is done and the equipment to do the work into a tidy package upon which demands may be placed for its service and work products.

Another type of DMF Party abstraction 22 is the Consumer Party. Consumer as a specialization of Party 22 is different than the other more role-neutral specializations (such as Corporation or Department) in that the Consumer Party has an owner. The owner of a Consumer Party is another Party. Thus, additional Fractal Aspects 20 that are owned by another Party are layered upon a Fractal Aspect 20. Such layered Fractal Aspects 20 are called “role-focused” Fractal Aspects 20. For example, if the ABC Corporation is a consumer of the XYZ Corporation, the XYZ Corporation may have information about the ABC Corporation in the role of consumer, such as its credit rating and normal payment terms. Therefore, the ABC Corporation as a consumer is also a Party of the XYZ Corporation, whose core object is the ABC Corporation.

The layered role-focused Fractal Aspect pattern is also useful for other Fractal Aspects 20, such as Location 24, Item 26 and Activity 28. As an example, if the ABC Corporation has a piece of equipment (Item 26) that they want to sell to the XYZ Corporation, in the DMF, the XYZ Corporation business analysts can create an instance of an Item layered Fractal Aspect called Product, whose core object is the equipment Item to be sold. The owner of this Product would be the ABC Corporation.

Once the Business Entity (Aspect 10) is defined (step 340), the DMF can “context shift” on the Business Entity 10 to implement the executable business model (step 350). Thus, in the DMF, it is possible to “shift” between Party 22, Location 24, Item 26 and Activity 28 Fractal Aspects of the Business Entity 10. For example, if a customer places a Demand 30 on a Party 22 of the Business Entity 10, the DMF can isolate and deal with only the Party Fractal Aspect 22. Likewise, if a customer needs to deliver something to a Location 24 of the Business Entity 10, the DMF can isolate and deal with the Location Fractal Aspect 24.

This shifting between Fractal Aspects 20 provides the DMF with the ability to process the Business Entity 10 in fuzzy terms by dealing with the Business Entity 10 as a collection of Fractal Aspects 20 as a whole. It also allows for the DMF to narrow the focus to a particular Fractal Aspect 20 of the Business Entity 10 within an operational context.

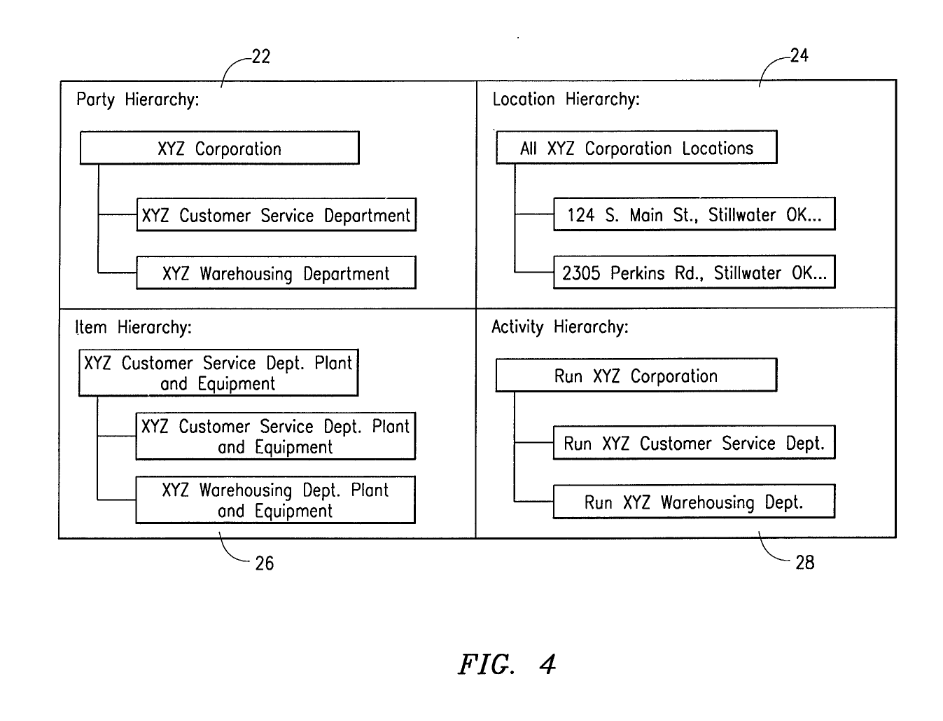

With reference now to FIG. 4 of the drawings, as alluded to above, DMF Fractal Aspects (Party 22, Location 24, Item 26 and Activity 28) have the capability to represent hierarchical whole-part, hereinafter referred to as “parent-child,” relationships in recursively decomposed structures. There exists not one hierarchy but many. A part can be a part in many contexts and therefore have many hierarchical parents. For example, the Party abstraction 22 can utilize this hierarchical capability to represent semantics, such as organizational structures. Activities 28 can apply the hierarchical capability to represent decomposable business processes. Location 24 can use it to model spatial topologies, such as sets of inventory bins and work cells inside warehouses and plants. Item 26 can use it to represent work-product assemblies and bills-of-materials.

The basic hierarchy pattern implemented by the Fractal Aspects can create hierarchies across all four Fractal Aspects simultaneously, as is shown, such that the hierarchies mirror each other. In more advanced examples, the hierarchies can diverge from each other. For example, the DMF can provide business analysts with the ability to reuse Locations 24, Items 26, and Activities 28 across Parties 22 using proxies (not shown), which are objects that stand-in for other objects. If the business analysts inputs a proxy to a Location 24, Item 26 or Activity 28 of a Party 22, the proxy points to another Location 24, Item 26 or Activity 28, respectively, for another Party 22. When the proxy is referenced, the proxy passes back the Location 24, Item 26 or Activity 28 it points to.

In addition, the Party Capabilities can be linked into a Party hierarchy that establishes who is responsible for overseeing the particular Party Capabilities. For instance, the XYZ Customer Service Department can be responsible for overseeing (administrating) the capability to accept an order. The XYZ Warehousing Department can be responsible for overseeing the capability to fulfill an order. These entities (XYZ Customer Service Department and XYZ Warehousing Department) stand hierarchically “above” the Party Capabilities (accept order and fulfill order, respectively). Thus, Party hierarchies can represent organizational structures that describe control, authority or oversight responsibility.

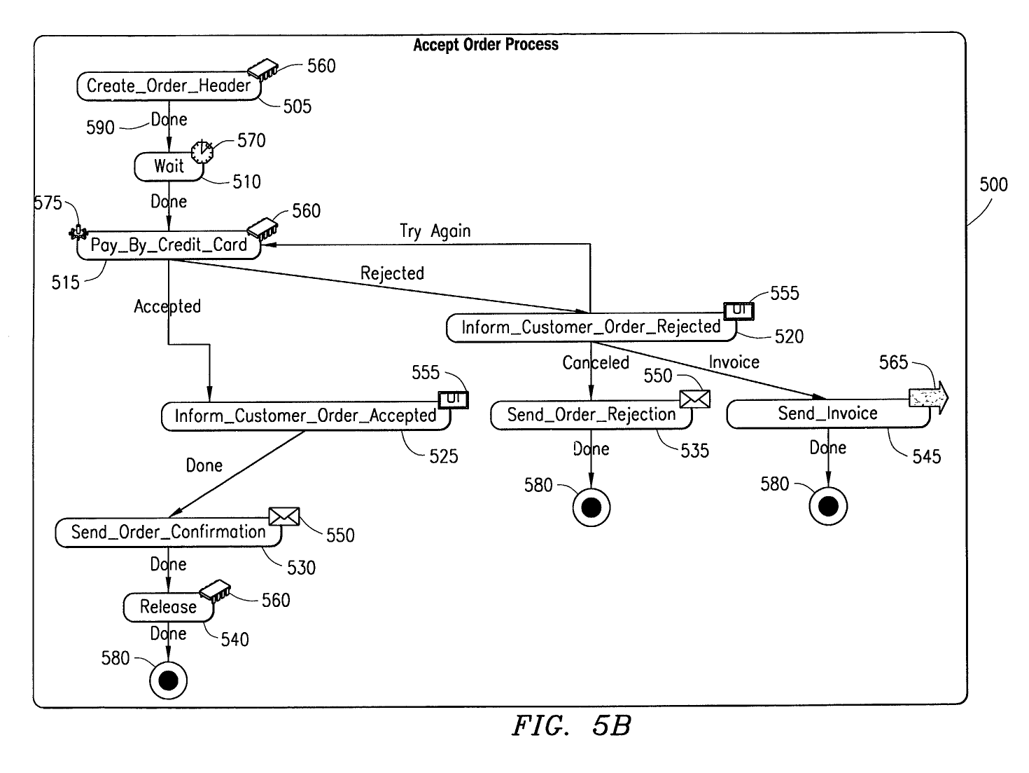

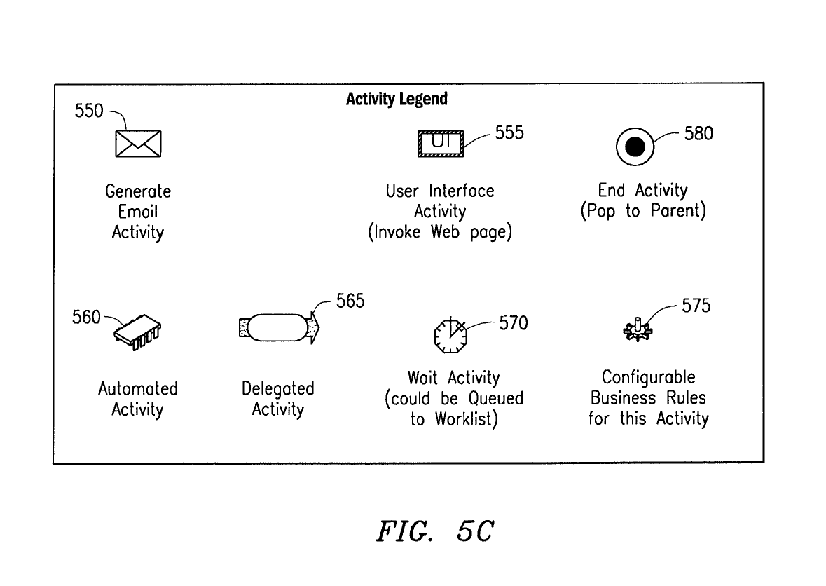

However, the Fractal Aspect's hierarchy features are insufficient in and of themselves for supporting things like business process design. Business process representation requires additional semantics. For example, a hierarchy of an Accept Order process as shown in FIG. 5A can also be expressed using additional semantics, as shown in FIGS. 5B and 5C. The first sub-Activity or Child Activity of the Parent “Accept Order Process” Activity 500 is the “Create Order Header” Activity 505. This is an automated Activity, as shown by an automation symbol 560, that occurs automatically when a customer inquires about ordering items from the XYZ Corporation. After the order header is created, the next Child Activity is a “Wait” Activity 510, which signifies that there is a Wait period, as shown by a wait symbol 570, to allow the customer to choose the items he or she wants to purchase. Once the customer has chosen the items to purchase, the next Child Activity, “Pay by Credit Card,” 515 is invoked. This Child Activity 515 is also an automated Activity, as shown by the automated symbol 560, that uses a configurable business rule, as shown by a configurable business rule symbol 575, to prompt the customer to enter credit card information.

If the credit card is rejected, the next Child Activity “Customer Order Rejected” 520 is invoked. This is a user interface Activity, as shown by a User Interface symbol 555, that allows the user to either enter another credit card number (invoking the “Pay by Credit Card” Child Activity 515 again), cancel the order (invoking a “Send Order Rejection” Child Activity 535, which generates an e-mail to the customer, as shown by a generate e-mail symbol 550) or request an invoice to be sent to the customer (invoking a “Send Invoice” Child Activity 545, which delegates this duty to another Party in the XYZ Warehousing Department or other Department, as shown by a delegated symbol 565). If the credit card is accepted, the next Child Activity “Inform Customer Order Accepted” 525 is invoked, which is a user interface activity, as shown by the user interface symbol 555, that allows the user to confirm purchasing the items. Thereafter, a “Send Order Confirmation” Child Activity 530 is invoked, which generates an e-mail to the customer, as shown by the e-mail symbol 550, and a “Release Order” Child Activity 540 is invoked, which is an automated activity, as shown by the automated symbol 560, that releases the order to the warehouse for fulfillment. After the “Release” order Child Activity 540, as shown by an end Activity symbol 580, the process reverts back to the Parent “Accept Order” Process Activity 500.

It should be noted that two Fractal Aspect hierarchy children can be associated through network relationships called Siblings. These are directed associations with a “from” Child and a “to” Child. A Sibling association associates a “from” Child with a “to” Child, and adds an Association Type. In the business process Sibling case, the Association Type is thought of as the “from” Child Activity's result. For example, as shown in FIG. 5B, the “Accept Order Process” Activity 500 shows both Child and Sibling associations. As an example, the “Create Order Header” Activity 505 and “Wait” Activity 510 children of the “Accept Order Process” Parent Activity 500 have a Sibling association with an Association Type “Done” 590.

It should be understood that the Child and Sibling mechanisms are also applicable to Party, Location and Item Fractal Aspects. For Party Aspects, the associations can be used to represent Sibling relations (such as partner relations) between peer (Child) Parties in the context of a (Parent) Party. For Location Aspects, the associations can be used to denote spatial relations between peer locations, such as “work area 1” is connected via a hallway to “work area 2,” in which the work areas are rooms inside a work center parent Location. In this case, “connected via hallway” is the Association Type. For Item Aspects, the associations can be used to denote physical relations between peer items, such as bill-of-material assembly “part A” is connected via a weld to “part B,” in which “connected via weld” is the Association Type.

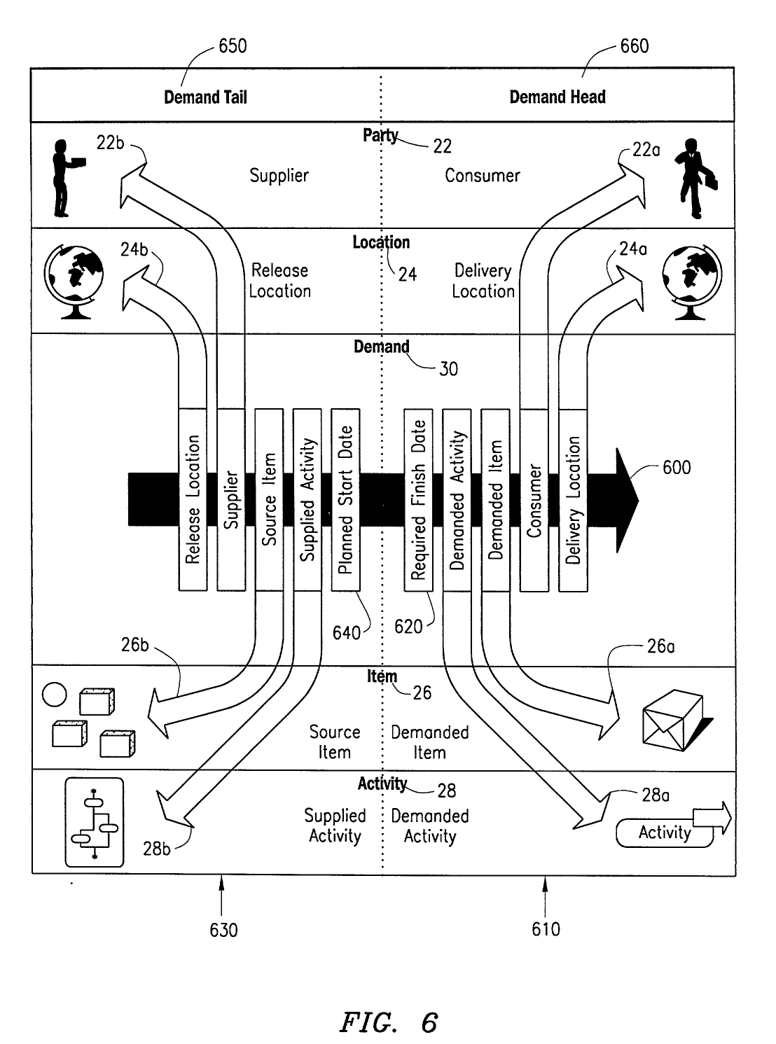

With reference now to FIG. 6 of the drawings, after the Fractal Aspects have been defined, Demands 30 can be made on the Business Entity. Demand 30 is an abstraction of business semantics such as an RFQ, purchase order, customer order, production order, maintenance request or any other form of agreement or contract between Parties for goods or services. Demand represents a consumer Party's 22a requirement for a demanded Activity 28a and/or Item 26a from a supplier Party 22b.

The DMF symbol for Demand 30 is an arrow 600. The arrow points in the direction of where the work product (the demanded Activity 28a or Item 26a) goes. Demand 30 is a symmetric business object with consumer and supplier ends 610 and 630, respectively. On the consumer end 610 is the Demanded Item 26a, Demanded Activity 28a, Demanded Finish Date 620 and Delivery Location 24a. On the supplier side 630 is the Supplied (source) Item 26b, Supplied Activity 28b, Scheduled Start Date 640 and Release Location 24b. This symmetry is leveraged for its clean separation of the consumer end 610 of the negotiated Demand 30 from the supplier end 630.

In FIG. 6, the Demand tail 650 is tied to a supplier Party 22b and a release Location 24b, while the Demand head 660 is tied to a consumer Party 22a and a delivery Location 24a. It should be understood that some Demands 30 are internal Demands that have the same Party 22 as both the consumer and the supplier, e.g., Production Order Demands.

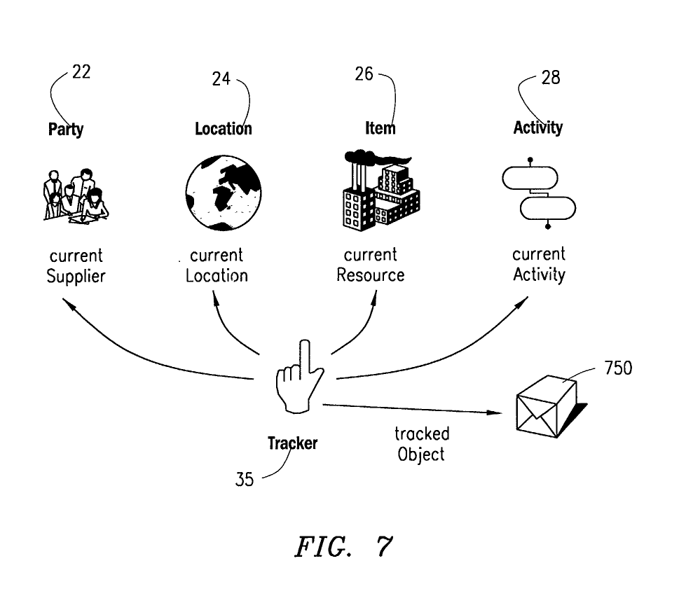

With reference now to FIG. 7 of the drawings, when a Demand is released for fulfillment (the Business Entity is performing a business activity), a Tracker 35 is created to track and drive Demand satisfaction. Tracker 35 is on one level a business process cursor, in that it is a pointer into an Activity Network 28. Tracker 35 invokes Activities 28 to execute business processes. However, Tracker 35 is more than an Activity Network 28 pointer. It also represents an entire business execution context. Tracker 35 knows which current Party 22 is responsible for performing an Activity 28, the current Activity 28 being performed, the tracked object 750 undergoing the Activity 28, the physical resources (Items 26) employed as tools to do the work, where the tracked object 750 is (its current Location 24) and other pertinent information.

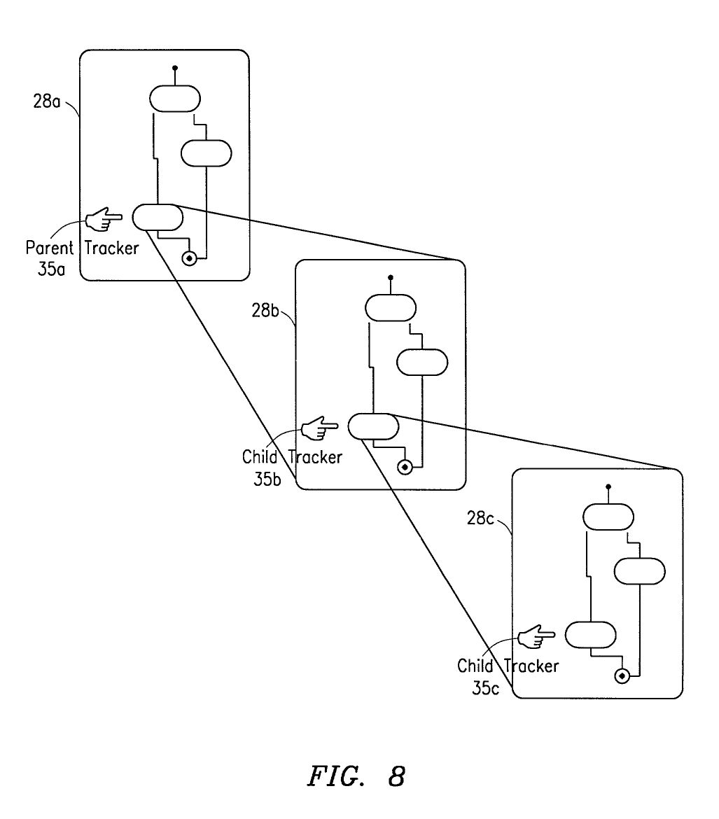

As shown in FIG. 8, Tracker 35 is also a stacking mechanism. For example, when Tracker 35a executes a decomposable business process Activity 28a, it creates “Child” Trackers 35b and 35c that dive down into the Activity Hierarchy and invoke each Activity Hierarchy Child 28b and 28b, respectively, in the order prescribed by the Activity Network Siblings. When a Child Tracker 35b or 35c finishes executing the Child Activities 28b or 28c, respectively, it pops back up to the Parent Tracker 35a, delivering the Child Activity's transformed work product to the Parent Tracker 35a so that the Parent Tracker 35a may proceed.

In addition, when an Activity 28 is outsourced (delegated) to another supplier Party (usually a Party Capability), Tracker 35 stacks itself just like it does when it encounters a business process Activity that has Child Activities. Once the supplier Party performs the Activity 28, the Tracker 35 pops back to the delegating Party for resumption of its responsibilities and re-establishment of the consumer Party business context.

Tracker 35 also provides support for exception handling. Exception handling enables an Activity's result (not shown) to be handled by another Parent Tracker, for example, Parent Tracker 35a, if the current Activity's Child has no Activity Sibling with the Activity's result. When this occurs, Tracker will throw an exception that will be caught by the nearest Parent Tracker 35a whose current Activity, for example, Activity 28a, or Child Activity, for example, Child Activity 28b, has a Sibling with the other Child Activity's result. When this occurs, the Parent Tracker 35a will traverse the Sibling and the Child Trackers are discarded.

In a running DMF system, there are typically many Trackers 35 executing simultaneously. However, the Activities 28 that a Tracker 35 invokes are not necessarily replicated for every instance of executing Tracker 35. Activities 28 can be reused over and over again for every Tracker 35 executing simultaneously.

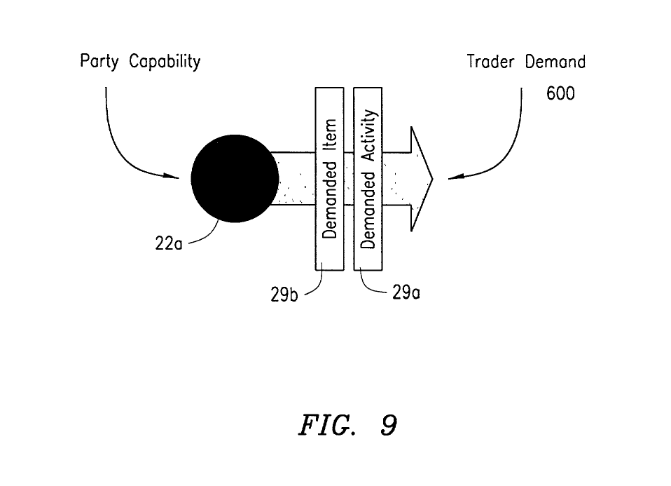

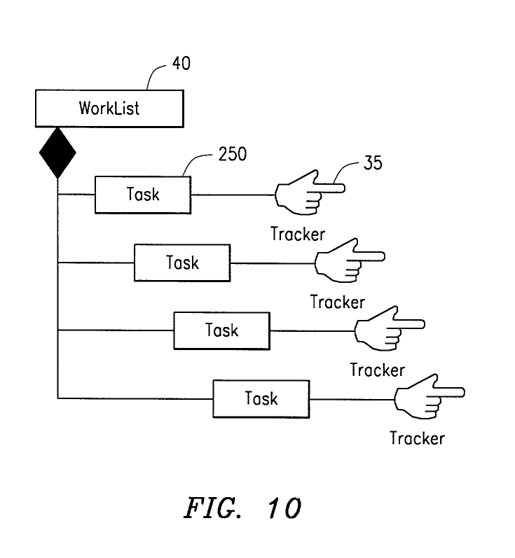

A specialized form of Tracker 35 occurs when Tracker 35 encounters an outsourced Activity 28 to a supplier Party. In this situation, with reference now to FIG. 9 of the drawings, Tracker performs one of several pluggable heuristics to search out a supplier Party Capability 22a to execute the Activity. One such heuristic uses a DMF Business Process Trader Service to locate a supplier Party Capability 22a. In this case, the term “Trader Service” is a label used to describe a software-based facility that is used to locate an object in a computer network that can perform a certain function or service. The DMF Business Process Trader Service is applied at the semantic level of locating business process supplier Parties.

To search out a supplier Party, a Party Capabilities 22a may also contain another abstraction called a Trader Demand 29. Trader Demand 29 is a DMF specialization of Demand that is used to advertise to Parties what the Party Capability 22a does. A Trader Demand 29 will have as its Demanded Activity 29a an Activity Specification describing the Party Capabilities 22a Activity. The Trader Demand 29 can also have an Item Specification as its Demanded Item 29b to describe the work product that is produced or transformed by the Demanded Activity.

For example, if the XYZ Corporation has a Party Capability of manufacturing product X, the Fractal Aspects for this Party Capability may be:

Capability to Produce Product X:

| | |
|---|---|
| Party: | Capability to Manufacture Product X |
| Location: | XYZ Manufacturing Facility |
| Item: | Assembly Line #4 |
| Activity: | Manufacturing Process X123 |
| Trader Demand | |
| Demanded Activity: | Produce |
| Demanded Item: | Product X |

The DMF Business Process Trader Service search heuristics utilize Trader Demands 29 to locate Party Capabilities 22a that can perform an Activity Specification and produce an Item Specification. When an Activity is delegated, Tracker 35 selects a Party from a list of the consumer Party's potential suppliers, which can be derived in a variety of ways. Each of these suppliers is typically a Corporation, but could also be a Department or some other specialization of Party.

Thereafter, the Trader Service search heuristic examines the selected Party, the selected Party's child Parties, and child Parties of the child Parties, etc., recursively downward traversing the tree of the selected Party Hierarchy, searching for Party Capabilities 22a that have Trader Demands 29 advertising the capability to perform the Activity Specification (Demanded Activity 29a) and transform or create the Item Specification (Demanded Item 29b).

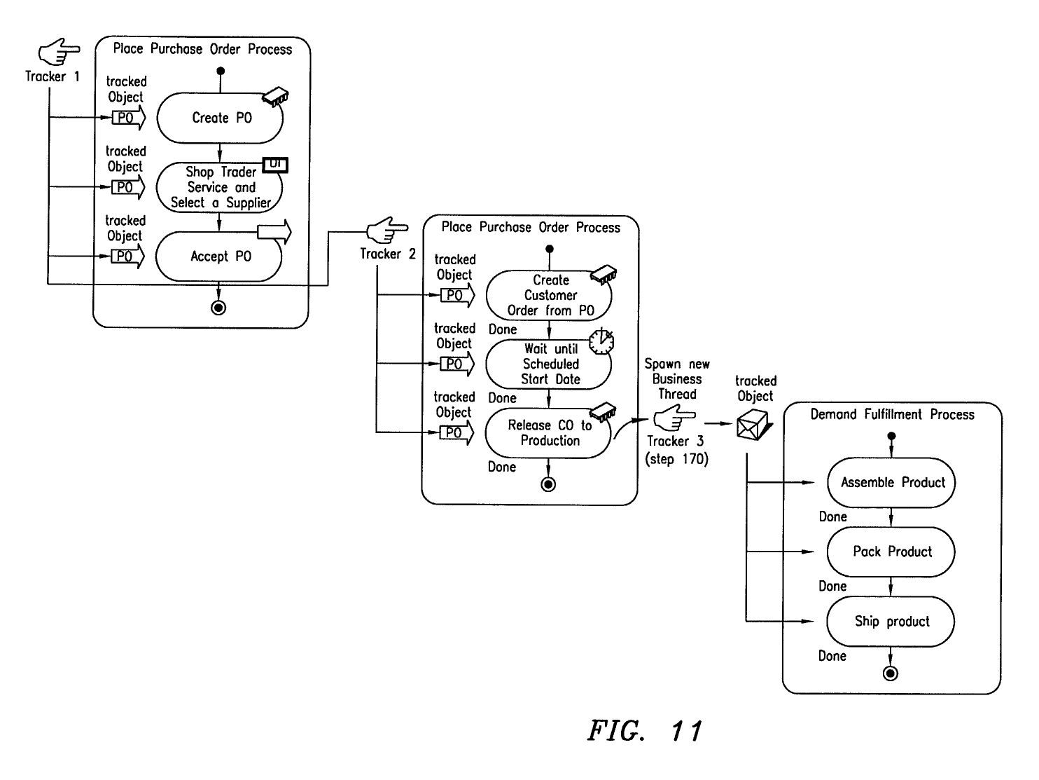

With reference now to FIG. 10, another type of Activity is a User Activity, which requires user input to complete the Activity. In some cases, the user is not presently available when the User Activity is invoked. Therefore, when Tracker 35 encounters a User Activity, Tracker 35 makes a determination as to whether or not it should queue itself as a Task 250 in a WorkList 40 associated with the user responsible for executing the User Activity. Tracker 35 queues itself in a WorkList 40 when a user (or other computer resource) is currently unavailable. For example, if a business process has multiple (child) steps that have the same user designation, and the current user has that designation, Tracker 35 most likely is able to continue invoking the User Activities for that user. Tracker 35 only queues itself as a Task 250 when it detects a change in supplier Party or a change in user designation. In either case, the current user (if one is currently involved in process execution) is no longer valid.

It should be noted that a WorkList 40 can be shared across users or a specific user may own it directly. In the shared case, the supplier Party's WorkList 40 is used, whereas in the specific user case, Tracker 35 queues itself in the specific users WorkList 40.

With reference now to FIG. 11, an overall view of a sample of a business activity process is shown, using the Demand, Tracker and WorkList abstractions. In this example, the creation and fulfillment of a Customer Order Demand is realized. Initially, a purchase order is placed by a customer for a Product. The business process for placing the purchase order is executed with a Tracker 35a. Tracker 35a first invokes a “Create Purchase Order” Automated Activity (step 100). This Activity creates an instance of the Purchase Order Demand object 750a, and sets this object as the Tracker's 35a tracked Object 750a.

When this is done, Tracker 35a next invokes a “Shop Trader Service and Select a Supplier” User Activity (step 110). This Activity allows the user to select a supplier based on a variety of Activity Specifications and Item Specifications defined by the user. For example, a dynamically created web page of suppliers can be provided to the user through a web server and the user's Browser. This list of potential suppliers can be retrieved in a variety of ways, as discussed above.

Once the user selects a supplier for the Purchase Order Demand, Tracker 35a encounters an “Accept Purchase Order Activity Specification” Delegation Activity (step 120). This indicates that a delegation is to occur to another Party. As discussed previously, Tracker 35a utilizes one of a collection of pluggable heuristics to determine the supplier for the Delegated Activity. For example, Tracker 35a can utilize the DMF Business Process Trader Service to locate a Party Capability to Accept the Purchase Order by invoking a method on the Tracker's tracked Object 750a. The effect of this is to ask the supplier Party for its capability to accept the purchase order, and to dynamically invoke that capability.

The Purchase Order Demand's root supplier is the Corporation that the purchase order is being placed against. The Party Capability is the Party within the Corporation that represents the business design that will actually accept the Purchase Order Demand. To accept the purchase order, Tracker 35a spawns a new Tracker 35b to execute an “Accept Purchase Order Process” Parent Activity of the Party Capability of the supplier Party (step 130).

Initially, the new Tracker 35b encounters a “Create Customer Order from Purchase Order” Activity (step 140) that creates a Customer Order Demand from the incoming Purchase Order Demand. This Activity sets the Customer Order Demand as the new Tracker's tracked Object 750b. Thereafter, the new Tracker 35b traverses the “Done” Sibling to the next Child Activity in the “Accept Purchase Order Process.” In this example, a “Wait until Scheduled Start Date” Activity is the next Child Activity (step 150). The “Wait until Scheduled Start Date” Activity queues the new Tracker 35b as a Task 250 to the WorkList 40 (shown in FIG. 10) of the supplier Party and sets a Timer (not shown) for auto-dequeuing the new Tracker 35b.

When the Customer Order Demand's Scheduled Start Date arrives, the Timer expires and the new Tracker 35b is de-queued from the WorkList. Thereafter, the new Tracker 35b traverses the next “Done” Sibling and invokes a “Release Customer Order to Production” Child Activity (step 160). This Child Activity spawns another new Tracker 35c (step 170). This new Tracker 35c sets as its tracked Object 750c the Demanded Product to be delivered to the customer, and encounters a Parent “Demand Fulfillment” Activity. The “Demand Fulfillment” Activity can include various Child Activities such as “Assemble Product,” (step 180) “Pack Product” (step 190) and “Ship Product” (step 195).

It should be noted that Activities like “Create Customer Order from Purchase Order” are specialized forms of Activity known as Bean Activities. Bean Activities are a type of Automated Activity that invokes other components. The invoked components are called Bean Activity Strategies (BAS), and are preferably implemented as JavaBeans. JavaBeans is the Java component model that is roughly equivalent to Microsoft's COM component model, except that JavaBeans is an implementation for the Java™ programming language.

When a Bean Activity invokes a Bean Activity Strategy (BAS), the BAS invokes a Tracker Event object. A Tracker Event is a parameter object that has a handle on the Tracker 35 that invoked the Bean Activity. Thus, the BAS gains access to the Tracker 35 through the Tracker Event object.

For example, referring again to FIG. 5B of the drawings, the “Pay by Credit Card” Activity 515 is a Bean Activity because it invokes other components. In this case, the other components are controlled by business rules (Activities), as indicated by the business rule icon 575 shown adjacent to the “Pay by Credit Card” Activity 515. The business rules can define, for example, the types of credit cards that are acceptable and the process for running a credit card through to determine whether payment by the credit card is accepted or declined by the credit card company.

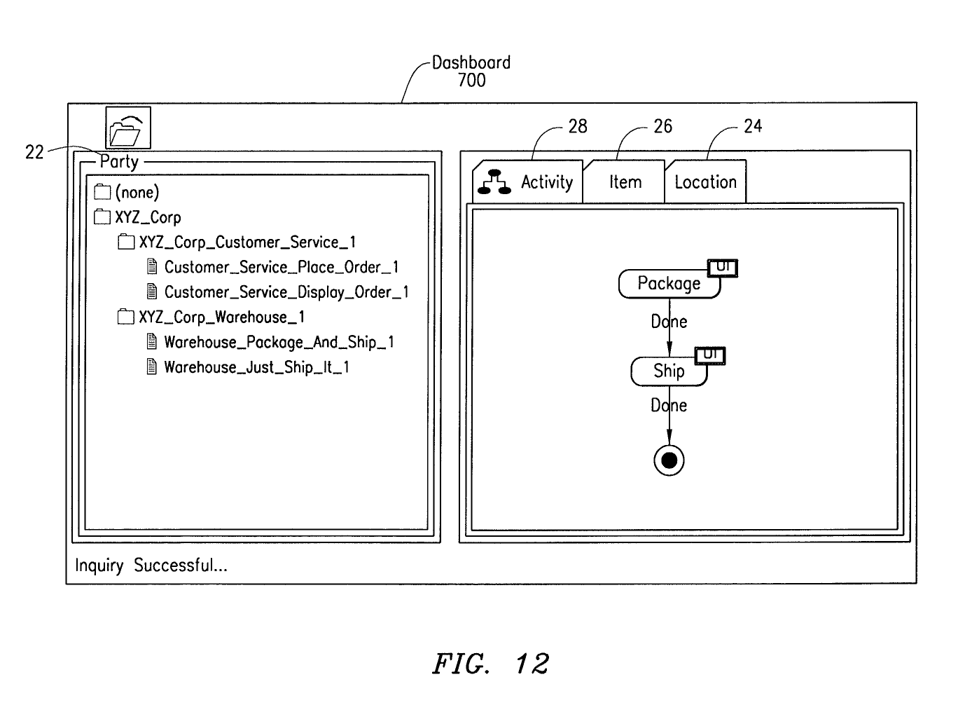

To create these business rules, with reference now to FIG. 12 of the drawings, a rule-configuration user interface (UI), called a Dashboard 700 is used. The Dashboard 700 allows business analysts to create and modify business processes, business rules, organizational structures, and all other elements of a DMF executable business model. The Dashboard 700 is the user interface business analysts use for building and maintaining DMF executable business models. Thus, from the Dashboard 700, the Party 22, Location 24, Item 26 and Activity 28 (business rules) can be created.

In the case of a Bean Activity, to modify the Bean Activity, the Dashboard 700 navigates to and arbitrates with the underlying BAS of the Bean Activity. The Dashboard 700 introspects the BAS to retrieve the BAS's business rules. From here, business analysts can modify the Bean Activity and/or create additional Bean Activities.

In the Dashboard 700 view, various objects can be displayed. For example, as shown in FIG. 12, the Dashboard 700 can display on the left-hand side, the Party 22 hierarchy and Parent Activities 28, while on the right-hand side, the Child Activities 28 of the highlighted Parent Activity 28 can be displayed. It should be understood that various views can be display on the Dashboard 700, such as the Location 24 and/or Item 26 associated with a highlighted Activity 28 or a list of all Activities 28 associated with a particular Party 22, etc.

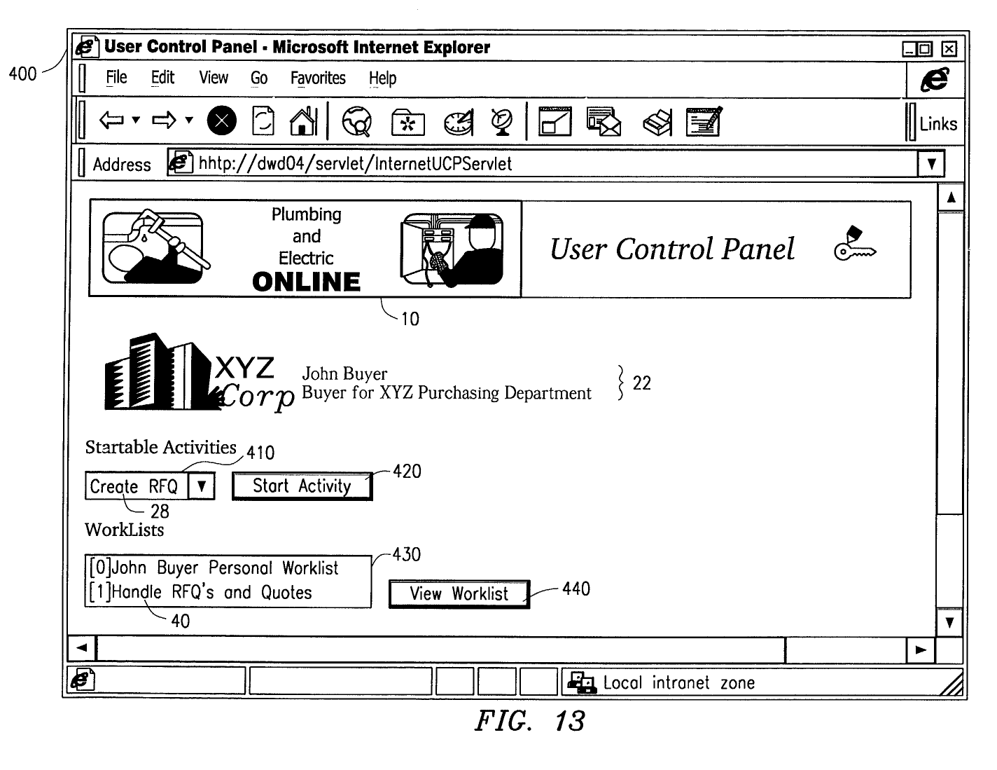

With reference now to FIG. 13, users can interact with the DMF 90 as a whole through a user interface called the User Control Panel (UCP) 400. This interface is preferably rendered as a web page. For example, as shown in FIG. 13, user John Buyer has logged onto the system and is assuming the role of Buyer for the XYZ Purchasing Department. John Buyer is operating within an online community called Plumbing and Electric (P&E) Online 10.

It should be understood that if John Buyer was able to assume other roles, the UCP web page would show an additional control section for selecting which role he wants to assume in the system. This accommodates people who work in different capacities for different organizations.

In the DMF, a user playing a particular role, e.g., John Buyer as Buyer for XYZ Purchasing Dept, is referred to as an Actor. An Actor associates a Person object (John Buyer) with an Actor Role (Buyer). Person, Actor and Actor Role objects are specializations of the Party abstraction 22. Another Party 22, e.g., XYZ Purchasing Dept, owns the Actor object. This establishes who the Actor works for, or more precisely, for whom the Actor is operating on their behalf. Thus, the Actor can be seen as an owned layered role-focused Fractal Aspect of a owning Party Fractal Aspect 22.

In the UCP 400, there is shown a Startable Activities selection list 410. This list is derived from the executable business model, in which each Activity 28 in the list is associated with the Actor Role designation. When John Buyer right-clicks on a start activity button 420, it creates a Demand for the Activity 28 shown in the Startable Activities box 410. In addition, a list 430 of WorkLists 40 that the Actor has access to are also shown on the UCP 400. The WorkLists 40 contain queued tasks 250 (shown in FIG. 10). By selecting a particular Worklist 40 from the list 440 of Worklists 40 and right-clicking on a View Worklist button 440, the tasks 250 for that Worklist 40 can be displayed. The Actor can then de-queue a task 250 from the selected WorkList 40 and resume business processing.

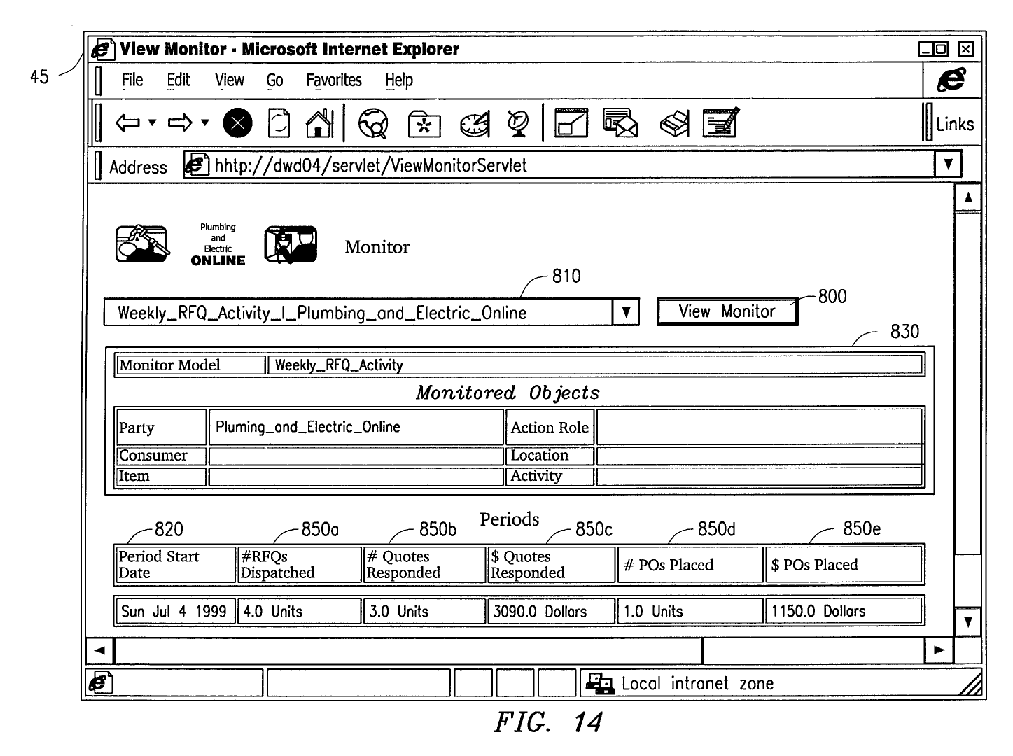

With reference now to FIG. 14 of the drawings, another core abstraction of the DMF is the Monitor 45. The Monitor 45 provides the ability to provide real-time summary views of an endless variety of business information. Monitor 45 creation and posting is business rule driven. Monitor 45 posting rules serve as probes into the DMF and are fired as the DMF executes. Instrumenting the executable business model with Monitors 45 gives even more control to the business analysts.

Monitors 45 can represent capacity plans, forecasts, material availability plans and other forms of summary Demand information. Monitors 45 can also be used to keep track of business process execution statistics, such as how often a process is executed in a given time period or how many times was a process canceled in that time period. Monitors 45 can have inventory views (not shown), illustrating the on-hand inventory, as well as projected time period views 820. The time periods, hereinafter referred to as Plan Periods 820, represent rolling past, present and future time slots. Inventory views and Plan Period views 820 each are made up of cells 850 that are posted to in real-time.

As shown in FIG. 14, by right-clicking on a View Monitor button 800, Monitor 45 displays a selected view 810 for a Monitored Object 830. In this example, a weekly summary of RFQ related Activity for the P&E Online Community Party is shown. Through this view 810, the online community can observe the total number and dollar amounts of RFQs, Quotes and Purchase Orders created across all member consumers and suppliers. If implemented on a web server, as is shown, this real-time view can be updated by pressing the browser's refresh button.

The Monitor view 810 in FIG. 14 contains a single Plan Period 820 for the Weekly RFQ Activity for the P&E Online Party (Monitored Object 830) for the week beginning Sunday Jul. 4, 1999. The view 810 shows that four RFQs (Request for Quotes) have been dispatched through the community to potential suppliers. Three Quotes have been returned in response to the RFQs with a total dollar amount of the Quotes equaling $3090. In addition, one Purchase Order has been rewarded to a supplier with a dollar amount of $1150. Thus, this Plan Period contains five cells: #RFQ Dispatched 850a, #Quotes Responded 850b, $ Quotes Responded 850c, #Purchase Order's Placed 850d, and $ Purchase Order's Placed 850e.

Monitors 45 are created and maintained by both Demand and Tracker, using Monitor 45 Posting Rules. Monitor 45 Posting Rules utilize sophisticated data caching techniques that dramatically improve Monitor 45 posting performance. Without these techniques, real-time posting would not be feasible.

Demands trigger Monitor 45 to post to a Monitor view 810 if a business rule exists for the Demand's root Supplier and a business rule exists for the Demand's consumer. Thus, two rule lookup processes occur before Demand posts to a Monitor view 810. One lookup occurs for the supplier end of the Demand (tail end) and another lookup occurs for the consumer end of the Demand (head end). This allows a single Demand post to both the consumer and supplier Monitor views 810.

Tracker triggers Monitor 45 to post to Monitor views 810 similar to the Monitor view 810 shown in FIG. 14. To support this, Tracker uses an additional rule called the Tracker Post Pattern rule. This rule is a pattern match rule that can be configured to trigger Tracker to Monitor 45 posting when particular Activities are executed. The rule can also be configured to fire maintenance of traditional inventory views, where counts of Items in Locations must be maintained. A Tracker Post Pattern rule is populated with patterns of Items combined with Locations, and Tracker executes the pattern match rules as it tracks Items entering and leaving Locations. Tracker Post Pattern Rules also utilize sophisticated data caching techniques to improve their performance.

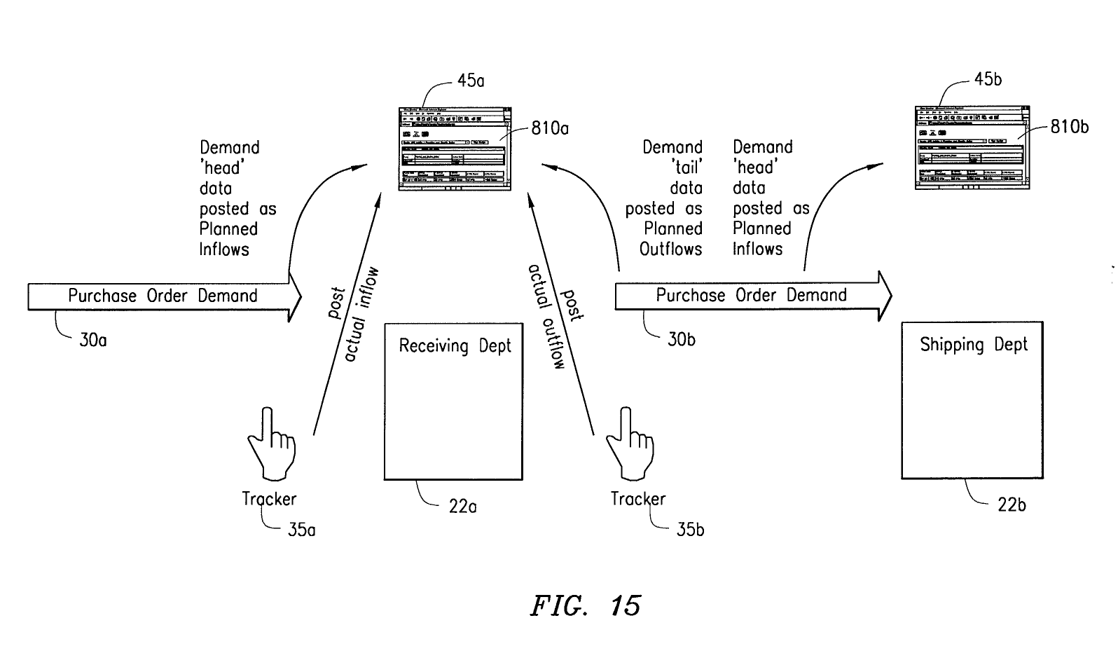

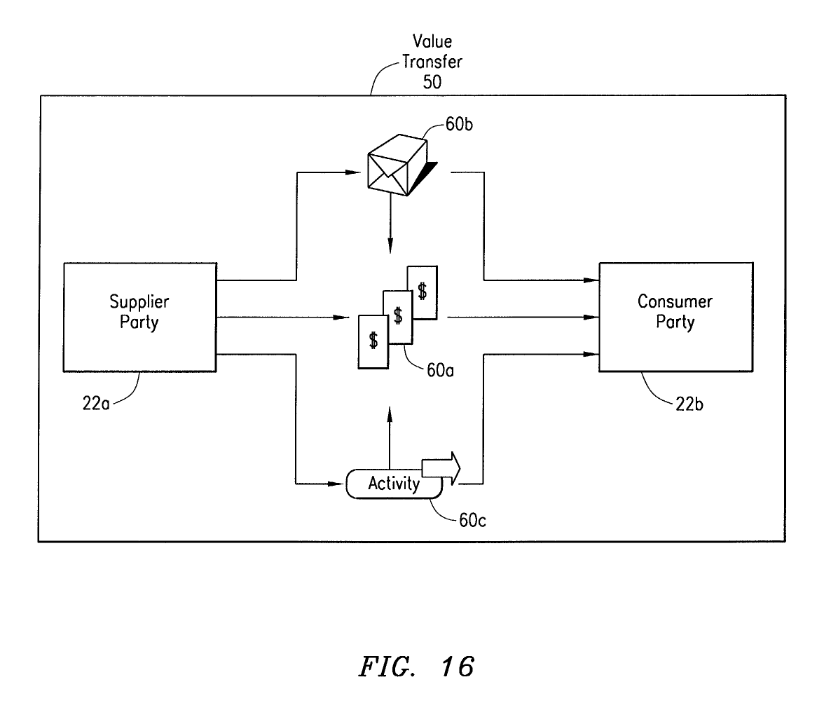

Monitors 45 can be used for a variety of purposes. For example, with reference now to FIG. 15 of the drawings, when a Purchase Order Demand 30a is received by a supplier Party 22a, e.g., a Receiving Department, the Purchase Order Demand 30a triggers Monitor 45a to post to a Monitor view 810a of the planned Purchase Order Demand data, such as the planned delivery Location, planned Item or Activity, planned quantity and planned finish date. Thereafter, when the supplier Party 22a creates a Production Order Demand 30b to fulfill the received Purchase Order Demand 30a, the Production Order Demand 30b triggers Monitor 45a to post to the same Monitor view 810a of the planned Production Order Demand data, such as that shown in FIG. 6, e.g., the planned supplier Party, planned release Location, the planned Item or Activity and the scheduled start date. Thus, Demand 30a and 30b posting to Monitor views 810a are used to post planned inflows to and outflows from supplier Parties 22a, such as the Receiving Department.

In addition, once the Activities, such as fulfilling the Production Order and Purchase Order Demands 30a and 30b, resepctively, are completed, Trackers 35a and 35b, resepctively, can trigger Monitor 45a to post the actual inflow and outflow data to the same Monitor view 810a. Therefore, this allows the Receiving Department 22a to view projected and net requirements for inventory. Therefore, shortages and surpluses can easily be forecasted, enabling supplier Partiesb 22a to notify purchases of projected shortages and adjust costs in case of surpluses.

The Demand 30 and Tracker 35 posting to Monitor views 810 can also be applied to other supplier Parties in the hierarchy, such as a Shipping Department 22b, which is responsible for fulfilling Production Order Demands 30b from the Receiving Department 22a. In this case, Demand 30b and Tracker (not shown) can trigger Monitor 45b to post to a Monitor view 810b for the Shipping Department 22b the planned and actual inflows and outflows of inventory in the Shipping Department 22b.

With reference now to FIG. 16 of the drawings, another DMF core abstraction is the Value Transfer abstraction 50. A Value Transfer 50 represents an economic event in which one Party 22a (a supplier) gives up a resource to another Party 22b (a consumer). The resource could be, for example, cash, a physical good or a unit of labor/service. In the DMF, cash is represented as a scalar quantity, and is recorded as a transfer Value object 60a of the Value Transfer abstraction 50. A physical good is represented as an Item in the DMF, and is recorded as a transfer Item object 60b. A service is considered an Activity, and is recorded as a transfer Activity object 60c. Both transfer Item 60b and transfer Activity 60c can be “costed” or valued, and the recorded value can be represented as the transfer Value 60a.

Some Value Transfers 50 represent actual economic exchange events, such as charges or commissions. However, Value Transfers 50 can also represent summarizations of other Value Transfers 50. Thus, Value Transfers 50 can post to other Value Transfers 50 through Value Transfer Posting Rules defined in the Dashboard 700 (shown in FIG. 12) by business analysts.

When a DMF Activity is completed, a Value Transfer Transaction groups a set of Value Transfers 50 that are generated as a reflection of exchanges of value that occur at the completion of the DMF Activity. Value Transfer Transaction creation is driven by Value Transfer Create Rules that specify which Value Transfers 50 to create for a given business event. For example, a Value Transfer Create Rule could prescribe the creation of two Value Transfers 50 when goods change locations and are delivered to the customer (the “deliver” Activity is complete). One Value Transfer 50 represents a charge to the customer, and another Value Transfer 50 represents a commission paid to an agent.

Value Transfer Create Rules can be executed automatically by Tracker as it records completion of an Activity. Value Transfer Create Rules can also be used to drive the presentation of summary Value Transfer user views to personnel (Actors) who manually enter transfer Item 60b quantities, transfer Activity 60c durations and transfer Values 60a.

For instance, if a Party runs a consulting practice and takes in cash for payment of services, the Party would realize a Value Transfer 50 that is posted to a summary Value Transfer view representing a cash account. The cash account posting could also trigger posts, for example, to a realized income account and a tax liability account.

The DMF system described above for defining executable business models and performing business activities can be implemented on a stand-alone computer, in a traditional client-server network or across multiple servers on the Internet. In addition, the DMF can host multiple companies and their automation solutions in a single (distributed) system. Likewise, the DMF can host multiple vertical communities in the same system and mix and match features and functions across them.

An implication of these capabilities is that ISPs (Internet service providers), ASPs (application service providers), and online e-commerce hubs and communities can use the DMF to deliver applications that support many simultaneous businesses and their users in collaborative ways. They can tailor functionality by vertical sector and even by individual company.

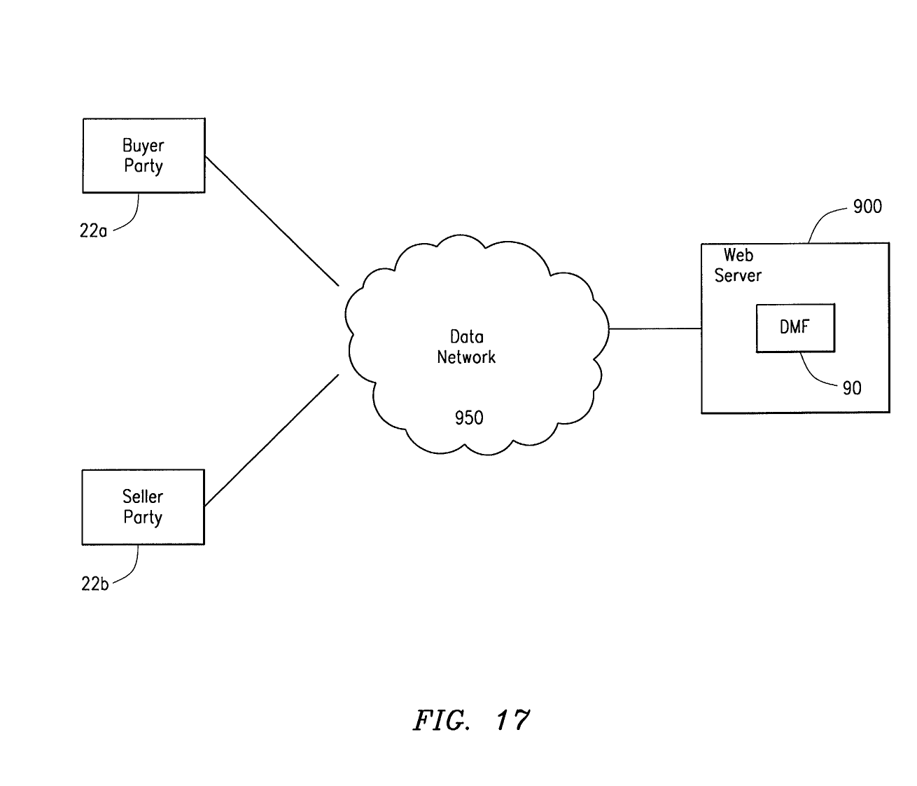

With reference now to FIG. 17 of the drawings, an example of a DMF system 90 operating on a web server 900 in a data network 950, such as the Internet, is shown. In this example, the DMF 90 is utilized by a Corporation, such as the P&E Online Corporation, to attract buyers 22a and sellers 22b by providing industry news, product announcements, product standardization efforts, etc. P&E Online generates revenue through advertising and lead generation revenue collected from sellers 22b. Leads are dispersed as e-mails to sellers 22b through buyer 22a requests from online catalogs hosted in the server 900.

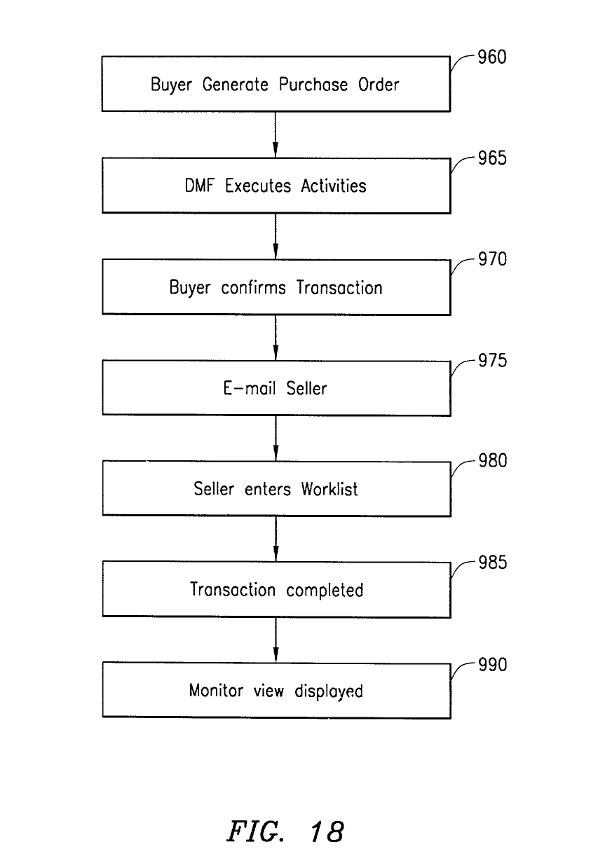

The DMF 90 is web-enabled, and its functions can be invoked by simply clicking a Uniform Resource Locator (URL) on a web page. For example, with reference now to FIG. 18 of the drawings, which will be described in connection with FIG. 17 of the drawings, when a buyer Party 22a wants to send a purchase order to a seller Party 22b, the buyer Party 22a can click on the URL for generating a purchase order for seller Party 22b (step 960). This purchase order generation process can be based on rules general to P&E Online or specific to the requirements of the seller Party 22b. Thus, the executable business model created by the P&E Online business analysts can be tailored to the individual members (seller Parties 22b).

When the buyer Party 22a clicks on the URL for generating a purchase order for the seller party 22b, this passes control to the DMF 90 and allows the DMF 90 to execute the defined business process Activities to generate the purchase order on the DMF web server 900 (step 965). Thereafter, the DMF 90 preferably instructs the web server 900 to push a web page to the buyer Party's 22a web browser. The web page displays the generated purchase order, and allows the buyer Party 22a to confirm the transaction (step 970).

Thereafter, the DMF 90 sends an e-mail to the seller Party 22b, notifying the seller Party 22b that there is work awaiting them in the web server 900 (step 975). When the seller Party 22b receives the e-mail, the seller Party 22b can click on a link to a web page that hosts a User Control Panel, containing a WorkList for the seller Party 22b, in the e-mail (step 980). It should be understood that while the DMF 90 is waiting for the seller Party 22b to logon to the web page and accept the purchase order, this Activity (accept the purchase order) is queued as a Task in the WorkList. Once the transaction is completed (buyer Party 22a and seller Party 22b exchange value) (step 985), the DMF 90 can display on a Monitor view for P&E Online of the results of the transaction and the Value Transfer for P&E Online that occurred due to the transaction (lead generation revenue) (step 990).

It should be noted that web point solution software such as page personalization servers, payment servers, and dialog servers, such as Vingette's™ Storyserver™ product, can also re-direct the web server 900 to invoke the DMF 90. Through this technology, the DMF 90 can be invoked by web point solution software, and using the same techniques, it can in turn invoke web point solutions. Therefore, context information can be bi-directionally sent between applications via URL parameters.

In addition, Parties and their related business objects can reside on different DMF web servers 900. For example, execution of an outsourced Activity can take place on a different web server that the web server on which an outsourcing Party resides. To support this, Tracker is capable of moving between servers across the Internet 950. Tracker technology, in combination with Fractal Aspect-based distributed executable business models, enables the DMF 90 to scale both physically and performance-wise across the Internet 950 or a server farm. This technology provides for distributed business processes that are executed at local server speeds.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A method for defining an executable software business model using a set of business abstraction types, comprising the steps of:
defining, on a computer software system, at least one party aspect of a business entity for a party type of said business abstraction types;
defining, on said computer software system, at least one location aspect of said business entity for a location type of said business abstraction types, said location aspect being associated with said defined party aspect for said business entity;
defining, on said computer software system, at least one item aspect of said business entity for an item type of said business abstraction types, said item aspect being associated with said defined party and location aspects for said business entity;
defining, on said computer software system, at least one activity aspect of said business entity for an activity type of said business abstraction types, said activity aspect being associated with said defined party, location and item aspects for said business entity; and
shifting dynamically between said business abstraction types to implement said executable software business model on said computer software system.

2. The method of claim 1, further comprising the step of:
repeating said steps of defining until all of said aspects of said business entity for each of said abstraction types have been defined.

3. The method of claim 2, further comprising the step of:
associating said aspects for each of said business abstraction types in respective parent-child relationships to produce a hierarchical pattern of said business entity on said computer software system.

4. The method of claim 3, wherein said step of associating further comprises the steps of:
associating a parent one of said party aspects with a child one of said party aspects in a party parent-child relationship;
associating a parent one of said location aspects associated with said parent party aspect with a child one of said location aspects associated with said child party aspect in a location parent-child relationship;
associating a parent one of said item aspects associated with said parent party and location aspects with a child one of said item aspects associated with said child party and location aspects in an item parent-child relationship; and
associating a parent one of said activity aspects associated with said parent party, location and item aspects with a child one of said activity aspects associated with said child party, location and item aspects in an activity parent-child relationship.

5. The method of claim 3, wherein said step of associating further comprises the steps of:
creating at least two children aspects for a respective parent aspect of a particular business abstraction type; and
associating said at least two children aspects in a sibling relationship using an association type.

6. The method of claim 1, wherein said step of defining at least one party aspect further comprises the step of:
defining at least one party capability aspect of said business entity for said party type of said business abstraction types.

7. The method of claim 1, wherein said step of defining at least one party aspect further comprises the step of:
defining at least one consumer party aspect of said business entity for said party aspect of said business abstraction types, said consumer party aspect being associated with a different business entity.

8. The method of claim 1, wherein said steps of defining are performed through a user interface on said computer software system.

9. A method for performing a business activity on a computer software system, comprising the steps of:
defining an executable software business model for a business entity on said computer software system using a set of business abstraction types, one of said business abstraction types being an activity type having at least one activity of said business entity associated therewith;
placing a demand on said computer software system to perform said at least one activity of said business entity;
performing said at least one activity of said business entity on said computer software system; and
creating a tracker to track satisfaction of said demand during said step of performing.

10. The method of claim 9, wherein said step of performing further comprises the steps of:
performing a parent one of said at least one activity, said parent activity having at least one child activity associated therewith in a hierarchical relationship, each of said child activities being associated together in respective sibling relationships, each of said sibling relationships having respective association types for prescribing an order of execution of said child activities; and
performing said at least one child activity in said order of execution prescribed by said sibling relationships and said association types.

11. The method of claim 10, wherein said step of creating further comprises the step of:
creating a first tracker to invoke said step of performing said parent activity; and
creating a second tracker to invoke said step of performing said at least one child activity.

12. The method of claim 9, wherein said at least one activity is a user activity, said user activity being associated with a particular party of said business entity, said particular party being defined as a party type of said business abstraction types on said computer software system.

13. The method of claim 12, wherein said step of creating further comprises the step of:
determining whether said particular party is a current party of said business entity involved in said step of performing, said current party being defined as said party type of said business abstraction types; and
if not, queuing said tracker as a task to a worklist associated with said particular party on said computer software system.

14. The method of claim 13, wherein said step of performing further comprises the steps of:
de-queuing said task from said worklist using a user interface on said computer software system; and
performing said user activity, using said tracker.

15. The method of claim 9, wherein said at least one activity is a delegation activity having an activity specification and an item specification associated therewith, said step of creating further comprising the step of:
selecting a parent party of said business entity, said parent party having at least one child party associated therewith in a hierarchical relationship, each of said child parties being associated together in respective sibling relationships, each of said sibling relationships having respective association types for defining a tree of said child parties, said parent party and said at least one child party both being defined as a party type of said business abstraction types on said computer software system; and
traversing said tree of said child parties, using said tracker, to locate a party capability of said at least one child party having the ability to perform said activity specification and create said item specification.

16. The method of claim 15, wherein said step of creating further comprises the steps of:
creating a first tracker to perform said steps of selecting and traversing; and
creating a second tracker to execute said delegation activity using said party capability of said parent party.

17. The method of claim 9, wherein said step of defining further comprises the step of:
defining said executable business model using a user interface on said computer software system.

18. The method of claim 9, wherein said step of placing said demand further comprises the step of:
placing said demand using a user interface on said computer software system.

19. The method of claim 9, further comprising the step of:
in response to completion of said step of performing, generating a set of value transfers indicative of exchanges of value that occurred during said step of performing, using said tracker.

20. The method of claim 9, further comprising the step of:
in response to said step of placing said demand, triggering a monitor feature to post to a monitor view on said computer software system data associated with said demand, said monitor view being viewable by a user of said computer software system, said user being a party of said business entity defined as a party type of said business abstraction types on said computer software system.

21. The method of claim 9, further comprising the step of:
in response to said step of performing said at least one activity, triggering a monitor feature to post to a monitor view on said computer software system work product results of the performance of said at least one activity, using said tracker.

22. A computer software system for executing a user-defined business model, comprising:
user-defined aspects of a business entity, each of said aspects being associated with a respective business abstraction type of said business model;
a user interface for receiving said aspects of said business entity for each of said business abstraction types; and
means for shifting dynamically between said business abstraction types to implement said user-defined business model.

23. The system of claim 22, further comprising:
means for associating said defined aspects for each of said business abstraction types in respective parent-child relationships to produce a hierarchical pattern of said business entity.

24. The system of claim 23, further comprising:
means for associating at least two children aspects of a respective parent aspect of a particular business abstraction type in a sibling relationship using an association type.

25. The system of claim 22, wherein one of said business abstraction types is an activity type having at least one activity for said business entity associated therewith, and further comprising:
an additional user interface for receiving a demand to perform said at least one activity of said business entity; and
means for performing said at least one activity of said business entity.

26. The system of claim 25, further comprising:
means for creating a tracker to track satisfaction of said demand during the performance of said at least one activity.

27. The system of claim 26, wherein said at least one activity is a user activity associated with a particular party of said business entity, said particular party being defined as a party type of said business abstraction types.

28. The system of claim 27, further comprising:
a worklist associated with said particular party, said tracker being queued as a task to said worklist when said particular party is not a current party of said business entity involved in the performance of said at least one activity, said current party being defined as said party type of said business abstraction types.

29. The system of claim 28, wherein said additional user interface is configured to de-queue said task from said worklist, the performance of said user activity continuing upon de-queuing of said task.

30. The system of claim 26, further comprising:
means for generating a set of value transfers indicative of exchanges of value that occurred during the performance of said at least one activity, using said tracker.

31. The system of claim 26, further comprising:
a monitor feature for triggering the display of a monitor view on a monitor associated with a computer implementing said computer software system, work product results of the performance of said at least one activity being posted to said monitor view, using said tracker.

32. The system of claim 25, further comprising:
a monitor for triggering the display of a monitor view on a monitor associated with a computer implementing said computer software system, data associated with said demand being posted to said monitor view.

33. The system of claim 22, wherein said computer software system is implemented on a web server connected to a data network.

34. The system of claim 33, wherein said user interface is accessible by remote users via said data network.

35. The system of claim 33, further comprising:
an additional user interface for interacting with said executable business model, said additional user interface being accessible by remote users via said data network.

36. The system of claim 35, wherein said additional user interface is presented to said remote users as a web page on said remote users web browser.
